(19) United States
(12) Patent Application Publication
(10) Pub. No.: US 2018/0188890 A1
(43) Pub. Date: Jul. 5, 2018

(54) ELECTRONIC WHITEBOARD SYSTEM AND ELECTRONIC WHITEBOARD AND OPERATION METHOD THEREOF

(71) Applicant: CHAMP VISION DISPLAY INC., HSINCHU COUNTY (TW)

(72) Inventors: Chin-Ku Liu, Hsin-Chu (TW); Chi-Wen Chen, Hsin-Chu (TW); Chih-Yuan Wang, Hsin-Chu (TW)

(73) Assignee: CHAMP VISION DISPLAY INC., HSINCHU COUNTY (TW)

(21) Appl. No.: 15/593,335

(22) Filed: May 12, 2017

(30) Foreign Application Priority Data
Dec. 30, 2016 (CN) 201611257464.6

(51) Int. Cl. G06F 3/042; G06F 3/0354; G06F 3/041; H04L 29/08

(52) U.S. Cl. CPC G06F 3/0425; H04L 67/10; G06F 3/0416; G06F 3/03545

(57) ABSTRACT

An electronic whiteboard system and an electronic whiteboard and operation method thereof are provided. A captured image generated by an image capture device includes at least one of a display surface of a flat panel display and a writing trajectory of a writing instrument. A network transmission module transmits the captured image to a remote device through network. The electronic whiteboard system and an electronic whiteboard and operation method thereof provided by the invention my synchronously display and interact with the remote device, so as to greatly improve convenience of use of the electronic whiteboard system.

### CROSS-REFERENCE TO RELATED APPLICATION

This application claims the priority benefit of China application serial no. 201611257464.6, filed on Dec. 30, 2016. The entirety of the above-mentioned patent application is hereby incorporated by reference herein and made a part of this specification.

### BACKGROUND OF THE INVENTION

### 1. Field of the Invention

The invention relates to an electronic device, and in particular, to an electronic whiteboard system and an electronic whiteboard and operation method thereof.

### 2. Description of Related Art

With development of touch technologies, touch devices gradually becomes basic equipment for electronic devices such as a notebook computer, a mobile phones, a tablet computer, or a portable multimedia player. A touch device may enable a user to perform touch operations through a gesture or by using input tools such as a stylus, and has features of being easy to operate and highly intuitive. Therefore, the touch device is loved by customers and becomes a main trend on the market. An electronic whiteboard having a touch function is a large touch device, and may be, for example, applied for educational use, so as to provide an environment for interactive operations. The electronic whiteboard now gradually replaces traditional devices such as blackboards or whiteboards, and is greatly applied to situations such as classrooms or meeting rooms. The electronic whiteboard generally has a function of writing by touch, and the user may use a tool such as a stylus to write or draw on the electronic whiteboard.

It is generally known that although the electronic whiteboard is more widely and conveniently applied as compared with the traditional whiteboard, the electronic whiteboard is limited to be used in the same place and cannot synchronously display or interact with a remote device. Therefore, the electronic whiteboard can still be improved.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention were acknowledged by a person of ordinary skill in the art.

### SUMMARY OF THE INVENTION

The invention provides an electronic whiteboard system and an electronic whiteboard and operation method thereof which my synchronously display or interact with a remote device, so as to greatly improve convenience of use of the electronic whiteboard system.

Other objectives and advantages of the invention may be further understood from the technical features disclosed in the invention.

To achieve at least one, some, or all of the aforementioned objectives or other objectives, the embodiments of the invention provide an electronic whiteboard including a flat panel display, a transparent plate, an image capture device, and a network transmission module. The flat panel display includes a display surface. The transparent plate is configured on the display surface, and includes a writing surface opposite to the display surface, where the writing surface is adapted to receive a writing operation of a writing instrument. The image capture device is coupled to the flat panel display and configured to capture an image of the transparent plate to generate a captured image, where the captured image includes at least one of the display surface of the flat panel display and a writing trajectory of the writing instrument. The network transmission module is coupled to the image capture device and configured to transmit the captured image to a remote device through network.

To achieve at least one, some, or all of the aforementioned objectives or other objectives, the embodiments of the invention provide an electronic whiteboard system including a first electronic whiteboard and a second electronic whiteboard. The first electronic whiteboard includes a first flat panel display, a first transparent plate, a first image capture device, and a first network transmission module. The first flat panel display includes a first display surface. The first transparent plate is configured on the first display surface, and includes a first writing surface opposite to the first display surface, where the first writing surface is adapted to receive a writing operation of a first writing instrument. The first image capture device is coupled to the first flat panel display and configured to capture an image of the first transparent plate to generate a first captured image, where the first captured image includes at least one of the first display surface of the first flat panel display and a first writing trajectory of the first writing instrument. The first network transmission module is coupled to the first image capture device. The second electronic whiteboard includes a second flat panel display, a second transparent plate, a second image capture device, and a second network transmission module. The second flat panel display includes a second display surface. The second transparent plate is configured on the second display surface, and includes a second writing surface opposite to the second display surface, where the second writing surface is adapted to receive a writing operation of a second writing instrument. The second image capture device is coupled to the second flat panel display and configured to capture an image of the second transparent plate to generate a second captured image, where the second captured image includes at least one of the second display surface of the second flat panel display and a second writing trajectory of the second writing instrument. The second network transmission module is coupled to the second image capture device, and transmits the first captured image and the second captured image through network with the first network transmission module, where the first flat panel display displays the second writing trajectory based on the second captured image, and the second flat panel display displays the first writing trajectory based on the first captured image, so as to synchronize images of the writing trajectories of the first captured image and the second captured image.

To achieve at least one, some, or all of the aforementioned objectives or other objectives, the embodiments of the invention provide an operation method of an electronic whiteboard system. The electronic whiteboard system includes a first electronic whiteboard and a remote device. The first electronic whiteboard includes a first flat panel display, a first transparent plate, a first image capture device, and a first network transmission module, the first flat panel display includes a first display surface, the first transparent plate is configured on the first display surface and includes a first writing surface opposite to the first display surface, and the operation method of the electronic whiteboard system includes the following steps: capturing an image of the first transparent plate to generate a first captured image, the first captured image including at least one of the first display surface of the first flat panel display and a first writing trajectory of the first writing instrument on the first writing surface; and transmitting the first captured image to the remote device through network.

On the basis of the above, the electronic whiteboard of the embodiments of the invention, the captured image including the display surface of the flat panel display and the writing trajectory may transmit to the remote device through network, so as to enable the electronic whiteboard to synchronously display and interact with the remote device, thereby greatly improving convenience of use of the electronic whiteboard system.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of an electronic whiteboard according to the embodiments of the invention.

FIG. 2 is a schematic diagram of an electronic whiteboard according to the embodiments of the invention.

FIG. 3 is a schematic diagram of an electronic whiteboard according to the embodiments of the invention.

FIG. 4 is a schematic diagram of a transparent plate and a light source according to the embodiments of the invention.

FIG. 5 is a schematic diagram of an electronic whiteboard according to the embodiments of the invention.

FIG. 6 is a schematic diagram of an electronic whiteboard system according to the embodiments of the invention.

FIG. 7 is a schematic diagram of an electronic whiteboard system according to the embodiments of the invention.

FIG. 8 is a schematic diagram of an electronic whiteboard according to the embodiments of the invention.

FIG. 9 is a schematic diagram of an electronic whiteboard system according to the embodiments of the invention.

FIG. 10 is a flowchart of an operation method of an electronic whiteboard system according to the embodiments of the invention.

FIG. 11 is a flowchart of an operation method of an electronic whiteboard system according to the embodiments of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

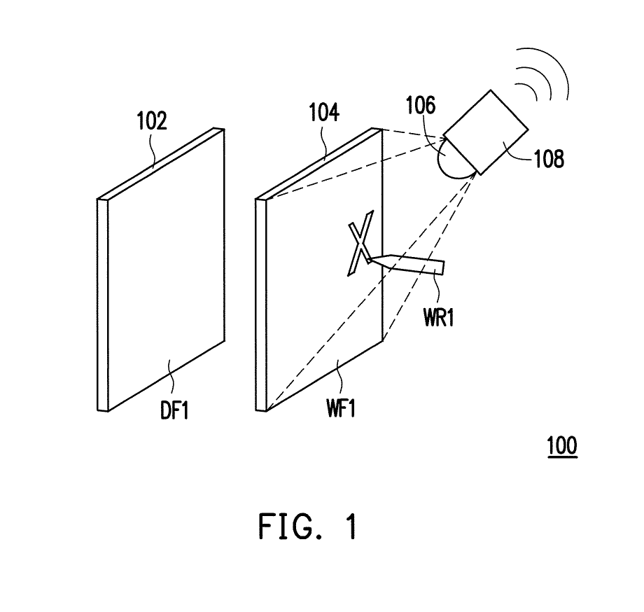

FIG. 1 is a schematic diagram of an electronic whiteboard according to the embodiments of the invention. Referring to FIG. 1, an electronic whiteboard 100 includes a flat panel display 102, a transparent plate 104, an image capture device 106, and a network transmission module 108. The image capture device 106 may be, for example, a camera, and may be coupled to the flat panel display 102. Moreover, the network transmission module 108 may be, for example, a wired or wireless transmission module such as an Ethernet (ethernet; ETH) module or a wireless network module, and may be coupled to the image capture device 106. The flat panel display 102 may be, for example, a display device such as a liquid crystal display, a plasma display, an LED display, an organic light-emitting diode (OLED) display, a capacitive touch display, an electromagnetic touch display, or a resistive touch display. That is, the flat panel display 102 of the electronic whiteboard 100 may have a touch function or may do not have the touch function but display only.

In some embodiments, the touch function may also be implemented by providing a touch device on the transparent plate 104. For example, an infrared light source is provided beside the transparent plate 104, so as to determine a touch position according to a situation of infrared light beam being blocked; or two corners at an upper edge of the transparent plate 104 are provided with CCD/CMOS cameras together with the infrared light source, so as to detect a shadow formed by a touch object and find the touch position through triangulation. Or ultrasonic transmitters and receivers are provided at three corners of the transparent plate 104, where ultrasonic transmission may form an even acoustic force field in a middle region. Energy may be absorbed when a surface wave touches a writing instrument or an instrument for touching (for example, sot medium such as fingers). A situation of acoustic waves being blocked is determined according to signals received by the receivers, so as to calculate the touch position. Through these manners, a writing surface WF1 of the transparent plate 104 may include writing and touch function at the same time. The transparent plate 104 is configured on the display surface DF1, and includes the writing surface WF1 opposite to the display surface DF1. The writing surface WF1 is far away from the display surface DF1, and is adapted to receive a writing operation of a writing instrument WR1.

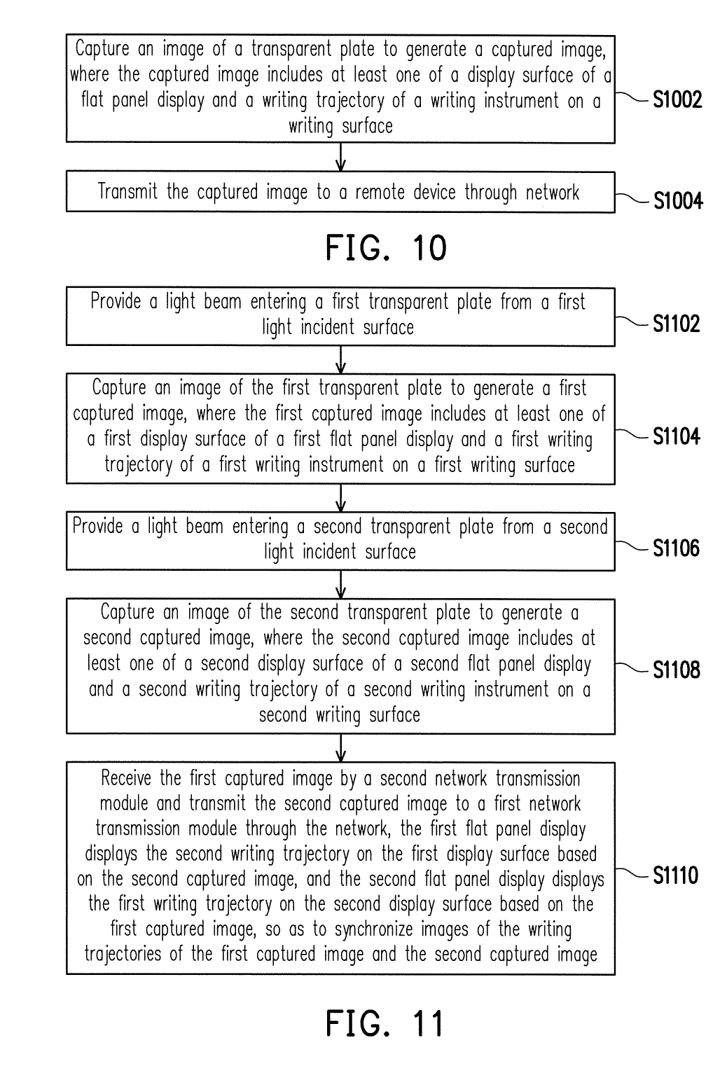

FIG. 10 is a flowchart of an operation method of an electronic whiteboard system according to the embodiments of the invention. Referring to both FIG. 1 and FIG. 10, the operation method of the electronic whiteboard system may include that, first, the image capture device 106 may capture an image of the transparent plate 104 to generate a captured image, where the captured image includes at least one of the display surface DF1 of the flat panel display 102 and a writing trajectory of the writing instrument WR1 (step S1002). In addition, in order to make the writing trajectory of the captured image easy to be identified or make the image capture device 106 easy to capture the writing trajectory, in the aforementioned step S1002, the flat panel display 102 may also be controlled to display a default image when the image capture device 106 performs image capturing. The default image is, for example, a white picture, a grey picture, a black picture, or a default pattern, but is not limited thereto. Therefore, the image capture device 106 merely captures the writing trajectory on the writing surface WF1, but does not capture an image displayed by the flat panel display 102. Subsequently, the network transmission module 108 may transmits the captured image to a remote device through network (step S1004), where the remote device may be, for example, another electronic whiteboard or a general display (that is, a display which does not have a function of an electronic whiteboard, such as a display screen, a tablet computer, or a notebook computer).

In this way, the network transmission module 108 transmits the captured image captured by the image capture device 106 to the remote device through the network, a display image seen by a user of the remote device and the captured image captured by the image capture device 106 may synchronize. In addition, the network transmission module 108 may also receive image data from the remote device, so as to interact with the remote device, thereby greatly improving convenience of use of the electronic whiteboard 100.

It should be noted that in some embodiments, a touch position of the writing instrument (such as a whiteboard marker) may further be determined according to the captured image captured by the image capture device 106. For example, the touch position of the writing instrument is determined based on the writing trajectory (such as ink) left on the writing surface WF1 by the writing instrument in the captured image, so as to execute relevant touch operations. Because the writing instrument only leaves the writing trajectory when actually touches the writing surface, situations of erroneous touch determinations which often occur in the optical touch technologies or the acoustic touch technologies may be avoided. That is, a situation of erroneous touch determination because infrared light beams or acoustic waves are blocked by accident by the user when the writing surface is not touched may be avoided.

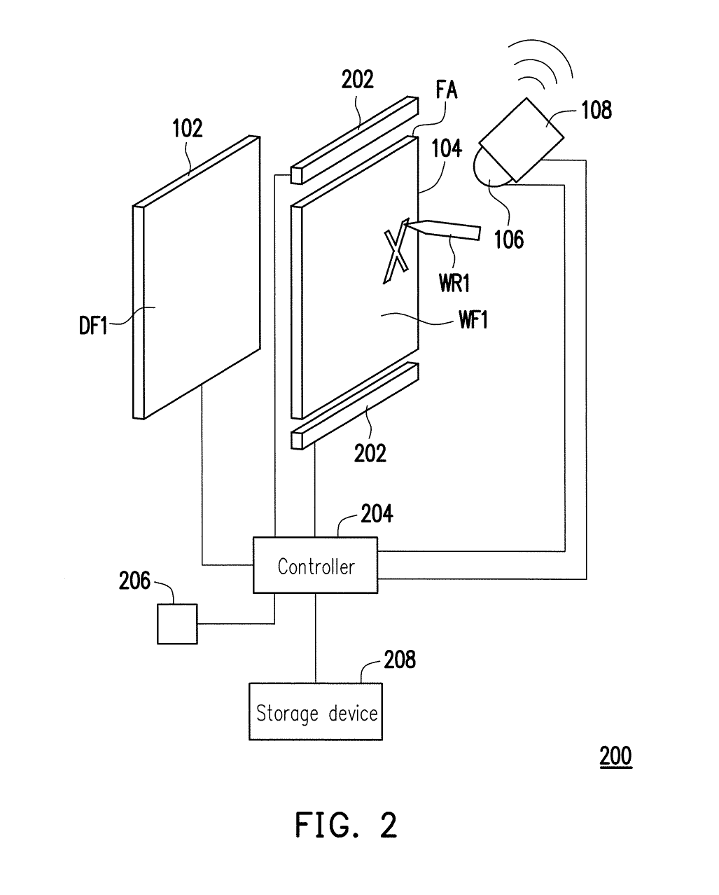

FIG. 2 is a schematic diagram of an electronic whiteboard according to the embodiments of the invention. Referring to FIG. 2, compared with the embodiments of FIG. 1, in the embodiment, an electronic whiteboard 200 further includes a light source 202, a controller 204, a transmission control button 206, and a storage device 208. The light source 202, for example, may include a light emitting diode (LED) or a cold cathode fluorescent lamp (CCFL), but is not limited thereto. The light source 202 is configured beside a light incident surface FA of the transparent plate 104, where the light incident surface FA is connected to the writing surface WF1 and is vertical to the writing surface WF1. In the aforementioned step S1002, a light beam entering the transparent plate 104 from the light incident surface FA may be provided by the light source 202. The transparent plate 104 may be, for example, a glass plate or a transparent plastic plate, but is not limited thereto. The light beam may be totally reflected in the transparent plate 104, and merely leaves the transparent plate 104 at a position on the writing surface WF1 which has a writing trajectory. Therefore, the user may obviously identify the writing trajectory. In detail, the writing instrument, for example, is a whiteboard marker. The writing trajectory written on the writing surface WF1 by the ink of the whiteboard marker, for example, may be a character or a pattern; and the ink may damage the total reflection of the light beam in the transparent plate 104, and scatters the light beam. Therefore, the light beam is emitted from the ink (the writing trajectory) on the writing surface WF1, and a clear character or pattern is represented, so that the user may obviously identify the writing trajectory.

The controller 204 is coupled to the flat panel display 102, the image capture device 106, the network transmission module 108, the light source 202, the transmission control button 206, and the storage device 208. The controller 204 may control the flat panel display 102 to display an image, control the image capture device 106 to perform image capturing, control the network transmission module 108 to transmit the captured image, control the storage device 208 to store the captured image, and further control the light source 202 to provide the light beam to the transparent plate 104. For example, when the flat panel display 102 is turned on and displays the image, the controller 204 may turns off the light source 202, and the image capture device 106, for example, may capture the image displayed by the flat panel display 102 and the writing trajectory on the writing surface WF1 at the same time. When the flat panel display 102 is turned off, the flat panel display 102 which is, for example, a liquid crystal display, often is black or in a deep color. Therefore, it is difficult to identify the writing trajectory written on the transparent plate 104. In order to make the writing trajectory easy to be identified, the controller 204 may control the light source 202 to be turned on, so as to provide a light beam to the light incident surface FA of the transparent plate 104. In addition, when the flat panel display 102 is turned on, in order to make the writing trajectory of the captured image easy to be identified or make the image capture device 106 easy to capture the writing trajectory, in the aforementioned step S1002, the controller 204 may also control the flat panel display 102 to display the default image when the image capture device 106 performs image capturing. The default image is, for example, a white picture, a grey picture, a black picture, or a default pattern. Therefore, the image capture device 106 merely captures the writing trajectory on the writing surface WF1, but does not capture an image displayed by the flat panel display 102. In addition, in the aforementioned step S1002, the transmission control button 206 may also be adapted to control time points for performing image capturing by the image capture device 106 and transmitting the captured image to the remote device. When the transmission control button 206 receives the press operation, the image capture device 106 may capture the image of the transparent plate 104, and the network transmission module 108 transmits the captured image to the remote device through the network. The captured image may also be stored into the storage device 208 for the user to watch in the future. The user may also transmit the captured image stored in the storage device 208 to the remote device by pressing the transmission control button 206. The storage device 208 may be, for example, a database, a memory, a Random Access Memory (RAM), an Electrically Erasable Programmable Read-Only Memory (EEPROM), another similar device, or a combination of these devices, but is not limited thereto.

It should be noted that, in the embodiment, the controller 204 is provided outside the flat panel display 102 and the image capture device 106. However, in some embodiments, the controller 204 may be built in the flat panel display 102 or the image capture device 106, but is not limited thereto. The controller 204 may be, for example, a central processing unit (Central Processing Unit, CPU), a programmable microprocessor (Microprocessor) for general or special purposes, a Digital Signal Processor (Digital Signal Processor, DSP), a programmable controller, an Application Specific Integrated Circuits (Application Specific Integrated Circuits, ASIC), a programmable logic device (Programmable Logic Device, PLD), another similar device, or a combination of these devices, but is not limited thereto. In addition, the transmission control button 206 may also be a physical button which may be, for example, integrated onto the flat panel display 102 or the image capture device 106. In some embodiments, the transmission control button 206 may also be a virtual button which is displayed on a display surface DF1 of the flat panel display 102.

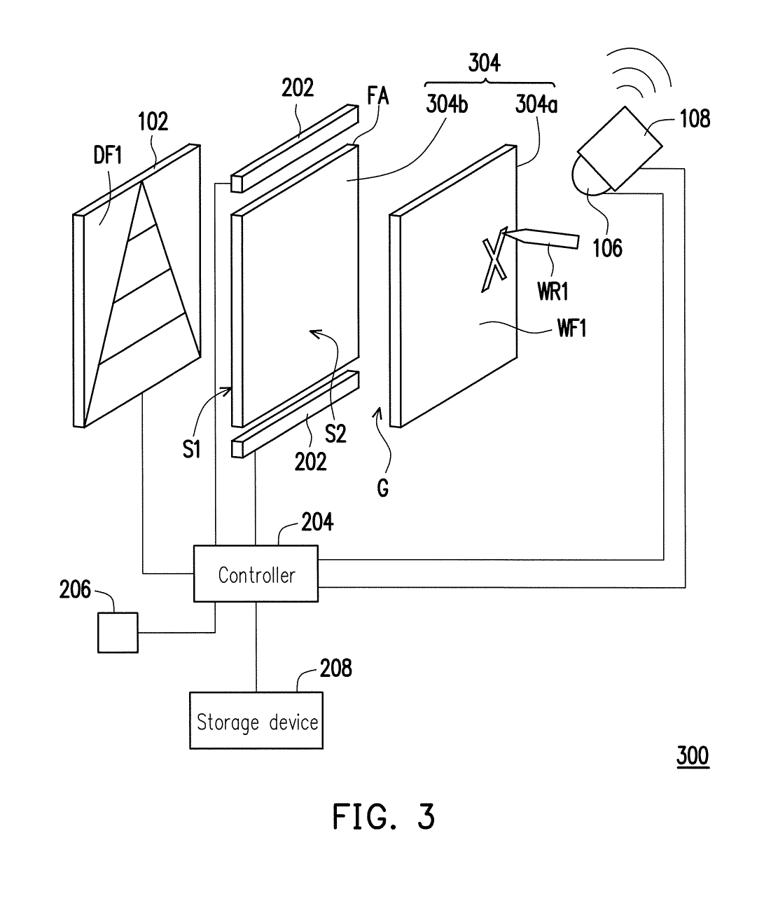

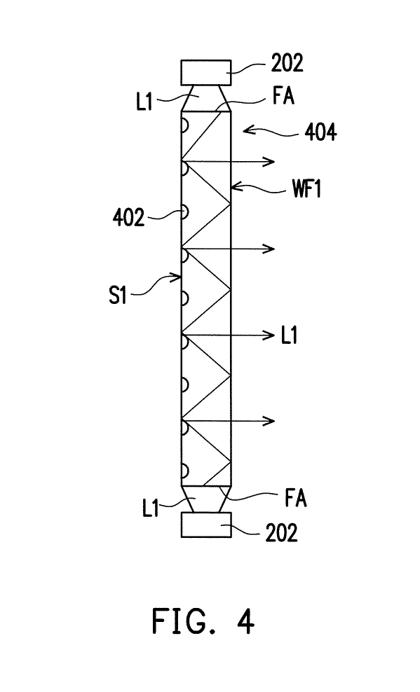

FIG. 3 is a schematic diagram of an electronic whiteboard according to the embodiments of the invention. Referring to FIG. 3, compared with the embodiments of FIG. 2, in the embodiment, a transparent plate 304 of an electronic whiteboard 300 may include a patterned scattering structure which may be, for example, a microstructure in a shape of a dot, a stripe, a straight line, a curve, or an island, but is not limited thereto. The patterned scattering structure is adapted to damage a total reflection of a light beam in the transparent plate 304, and scatter the light beam to enable the light beam to be emitted from the transparent plate 304 (such as from the writing surface WF1), so as to form an even planar light source. For example, FIG. 4 is a schematic diagram of a transparent plate and a light source according to the embodiments of the invention. As shown in FIG. 4, a transparent plate 404 is provided with a plurality of dot-shaped patterned scattering structures 402 at a surface S1 opposite to the writing surface WF1 (in some embodiments, the patterned scattering structures 402 may also be provided at a side of the writing surface WF1). In detail, both the patterned scattering structures 402 provided on the surface S1 and the ink written on the writing surface WF1 damage a total reflection of a light beam in the transparent plate 404. As a result, contrast of the writing trajectory is worse, and it is difficult for the user to identify the writing trajectory. Therefore, ink of lower permeability may be selected to improve this problem.

In addition, in the embodiments of FIG. 3, the transparent plate 304 may also be a composite structure. The transparent plate 304 may include an upper plate 304a and a lower plate 304b, the lower plate 304b includes the light incident surface FA and the patterned scattering structures 402 (not shown in the figure), where the lower plate 304b is located between the flat panel display 102 and the upper plate 304a, the patterned scattering structures 402 may be provided on at least one of the surface S1 or a surface S2, and the writing surface WF1 is located at the upper plate 304a. In the embodiment, there is, for example, a gap G between the upper plate 304a and the lower plate 304b. In some embodiments, there may not be the gap G between the upper plate 304a and the lower plate 304b. In the aforementioned step S1002, a total reflection may occur in a lower plate 304b after a light beam L1 provided by the light source 202 enters the lower plate 304b of the transparent plate 304 from the light incident surface FA. The light beam L1 is guided outside from the surface S2 only when touching the patterned scattering structures 402. The lower plate 304b forms an even planar light source to illuminate an upper plate 304a, but a writing trajectory located on the upper plate 304a may shield a part of the light beam leaving from the writing surface WF1, being helpful to improve identifiability of the writing trajectory. In addition, in the embodiment, materials of the upper plate 304a and the lower plate 304b of the transparent plate 304 are different. The upper plate 304a is, for example, a glass plate and helps to write or erase the ink and protect the lower plate 304b and the flat panel display 102. However, the lower plate 304b is, for example, a transparent plastic plate and helps to make the patterned scattering structure. Moreover, the transparent plastic plate is, for example, a polymethyl methacrylate (Polymethyl methacrylate, PMMA) or a polycarbonate (Polycarbonate, PC), but is not limited thereto.

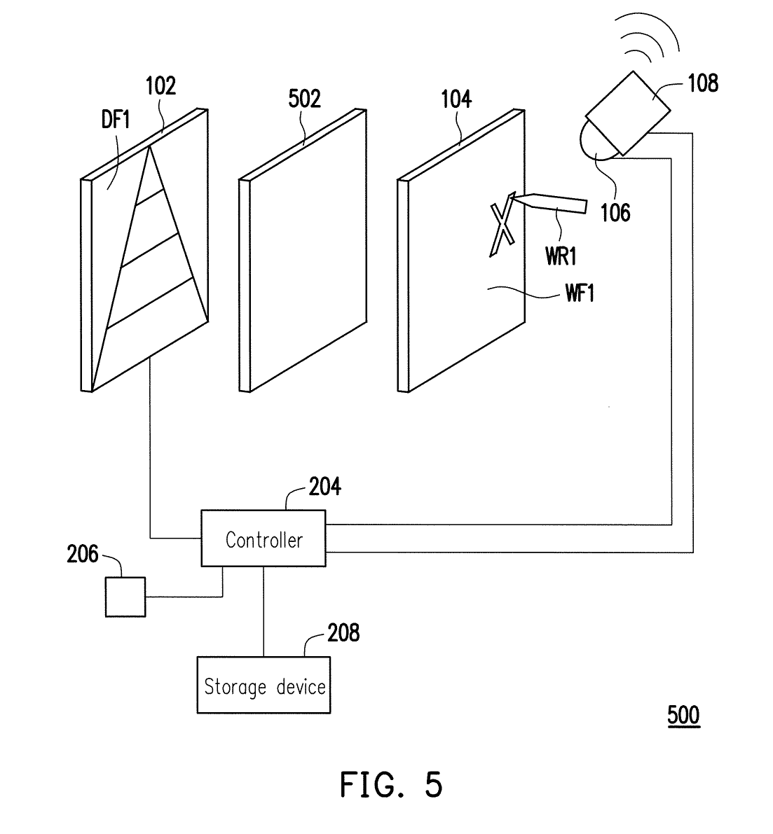

FIG. 5 is a schematic diagram of an electronic whiteboard according to the embodiments of the invention. Referring to FIG. 5, compared with the embodiments of FIG. 2, in the embodiment, an electronic whiteboard 500 further include a polymer dispersed liquid crystal (PDLC) layer 502. The polymer dispersed liquid crystal layer 502 is configured between the flat panel display 102 and the transparent plate 104, and the controller 204 is coupled to the polymer dispersed liquid crystal layer 502, so as to control the polymer dispersed liquid crystal layer 502 to be switched into a transparent state or a non-transparent state. In the aforementioned step S1002, the polymer dispersed liquid crystal layer 502 may also be switched into the transparent state when the flat panel display 102 is turned on and displays an image. The image capture device 106, for example, may capture the image displayed by the flat panel display 102 and the writing trajectory on the writing surface WF1 at the same time. However, when the flat panel display 102 is turned off, the polymer dispersed liquid crystal layer 502 may be switched into the non-transparent state, so that the writing trajectory on the writing surface WF1 is easier to be identified. Or, when the flat panel display 102 displays the default image, the polymer dispersed liquid crystal layer 502 may be switched into the non-transparent state, so that the writing trajectory on the writing surface WF1 is easier to be identified, and the image capture device 106 may capture the writing trajectory on the writing surface WF1 only.

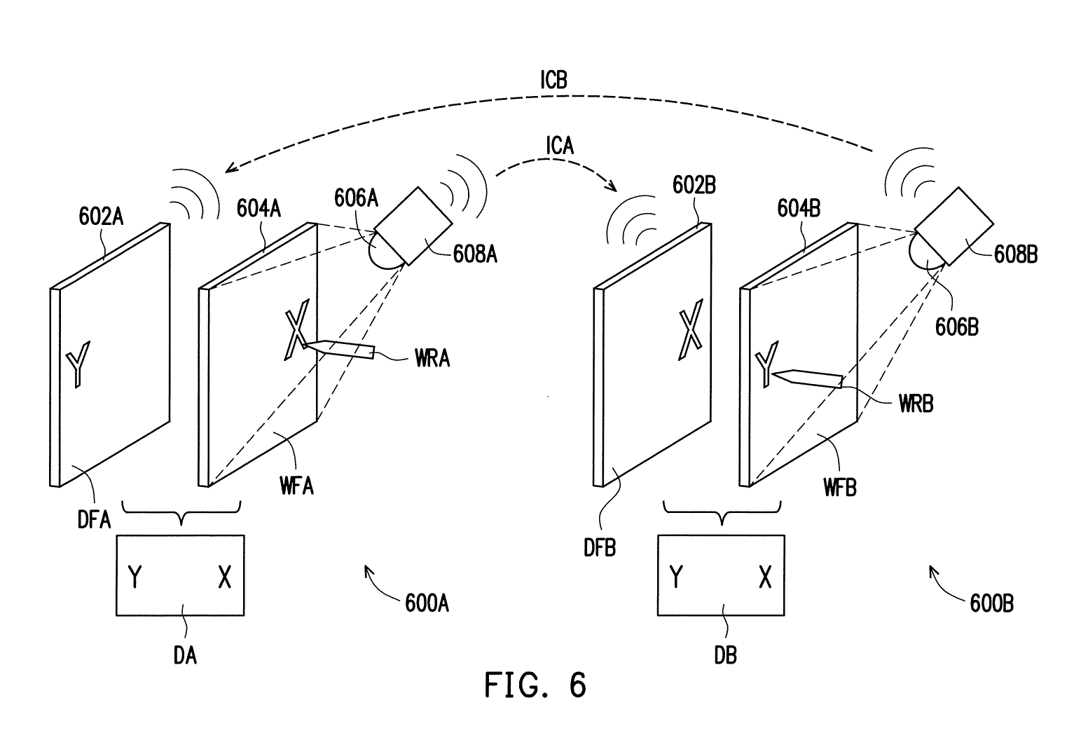

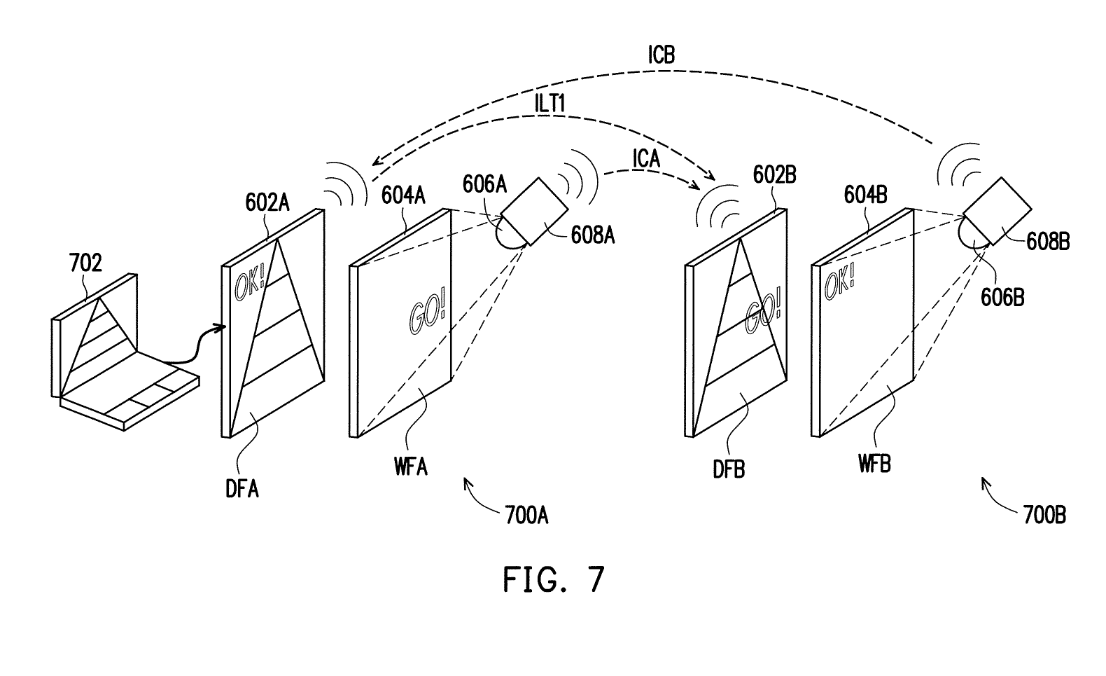

FIG. 6 is a schematic diagram of an electronic whiteboard system according to the embodiments of the invention. Referring to FIG. 6, an electronic whiteboard system includes a first electronic whiteboard 600A and a second electronic whiteboard 600B. The first electronic whiteboard 600A includes a first flat panel display 602A, a first transparent plate 604A, a first image capture device 606A, and a first network transmission module 608A. The second electronic whiteboard 600B includes a second flat panel display 602B, a second transparent plate 604B, a second image capture device 606B, and a second network transmission module 608B. Devices respectively included in the first electronic whiteboard 600A and the second electronic whiteboard 600B are same to those in the aforementioned embodiments. Therefore, the descriptions of functions of the devices of the first electronic whiteboard 600A and the second electronic whiteboard 600B are omitted herein. In addition, in order to keep the diagram simple, devices such as the light source, the controller, the transmission control button, and the storage device are not shown in FIG. 6 (and FIG. 7 to FIG. 9 described below). FIG. 11 is a flowchart of an operation method of an electronic whiteboard system according to the embodiments of the invention, where the first electronic whiteboard 600A and the second electronic whiteboard 600B use, for example, the electronic whiteboard 200 of the embodiments of FIG. 2 as an example. Referring to FIG. 2, FIG. 6, and FIG. 11, the operation method of the electronic whiteboard system may include, first, providing a light beam entering the first transparent plate 604A from a light incident surface of the first transparent plate 604A (step S1102), where the light beam may be totally reflected in the first transparent plate 604A by a first writing surface WFA which does not include a first writing trajectory, and leaves the first transparent plate 604A from the first writing trajectory on the first writing surface WFA. In some embodiments, the first transparent plate 604A may include, as shown in the embodiments of FIG. 3 and FIG. 4, a patterned scattering structure, so as to guide the light beam to leave from the first writing surface WFA; and the first writing trajectory on the first writing surface WFA may shield a part of the light beam leaving from the first writing surface WFA, thereby helping to improve identifiability of the first writing trajectory. Subsequently, the image capture device 606A may capture an image of the first transparent plate 604A, so as to generate a first captured image ICA, where the first captured image ICA may at least one of the first display surface DF1 of the first flat panel display 602A and the first writing trajectory of a first writing instrument WRA on the first writing surface WFA (step S1104).

Subsequently, a light beam entering the second transparent plate 604B from a light incident surface of the second transparent plate 604B is provided (step S1106), where the light beam may be totally reflected in the second transparent plate 604B by a second writing surface WFB which does not include a second writing trajectory, and leaves the second transparent plate 604B from the second writing trajectory on the second writing surface WFB. Similarly, the second transparent plate 604B may include, as shown in the embodiments of FIG. 3 and FIG. 4, a patterned scattering structure, so as to guide the light beam to leave from the second writing surface WFB; and the second writing trajectory on the second writing surface WFB may shield a part of the light beam leaving from the second writing surface WFB, thereby helping to improve identifiability of the second writing trajectory. Subsequently, the image capture device 606B may capture an image of the second transparent plate 604B, so as to generate a second captured image ICB, where the second captured image ICB may include at least one of the second display surface DFB of the second flat panel display 602B and the second writing trajectory of a second writing instrument WRB on the second writing surface WFB (step S1108).

Finally, through the network, the second network transmission module 608B may receive the first captured image ICA from the first network transmission module 608A and transmits the second captured image ICB to the first network transmission module 608A, so that the first flat panel display 602A displays the second writing trajectory on the second writing surface WFB based on the second captured image ICB, and the second flat panel display 602B displays the first writing trajectory on the first writing surface WFA based on the first captured image ICA, so as to synchronize images of the writing trajectories of the first captured image ICA and the second captured image (step S1110).

In this way, the display surfaces of the flat panel displays and the captured images of the writing trajectories by using the first electronic whiteboard 600A and the second electronic whiteboard 600B transmitting through network may enable the first electronic whiteboard 600A and the second electronic whiteboard 600b to display synchronously. As shown in FIG. 6, the first writing trajectory “X” on the first writing surface WFA may be displayed on the second display surface DFB of the second flat panel display 602B, and the second writing trajectory “Y” on the second writing surface WFB may be displayed on the first display surface DFA of the first flat panel display 602A, so that images DA and DB respectively seen by the users of the first electronic whiteboard 600A and the second electronic whiteboard 600B have the same content. By performing synchronous display continuously, the users of the first electronic whiteboard 600A and the second electronic whiteboard 600B may be enabled to interact with each other, so as to greatly improve convenience of use of the electronic whiteboard system.

For another example, as shown in the electronic whiteboard system of the embodiments of FIG. 7, the embodiment of FIG. 7 differs from the embodiments of FIG. 6 in that in the embodiment, the electronic whiteboard system further includes an image data providing device 702 which may be, for example, a notebook computer, a tablet computer, or any other electronic device which may provide image data ILT1. The image data providing device 702 may provide the image data ILT1 to the first flat panel display 602A to be displayed, the image data ILT1 also transmits to the second flat panel display 602B through the network to be displayed (the image data ILT1 may be transmitted by the image data providing device 702 or a network transmission module in the first flat panel display 602A, and may be received by a network transmission module in the second flat panel display 602B). Similarly, a first electronic whiteboard 700A and a second electronic whiteboard 700B may also transmit the first captured image ICA captured by the first image capture device 606A and the second captured image ICB captured by the second image capture device 606B with each other by using the first network transmission module 608A and the second network transmission module 608B, so that users of the electronic whiteboard 700A and the second electronic whiteboard 700B see the same content at the electronic whiteboard 700A and a second electronic whiteboard 700B, respectively. The users may see an image of the image data ILT1, a first writing trajectory “GO!” on the first writing surface WFA, and a second writing trajectory “OK!” on the second writing surface WFB.

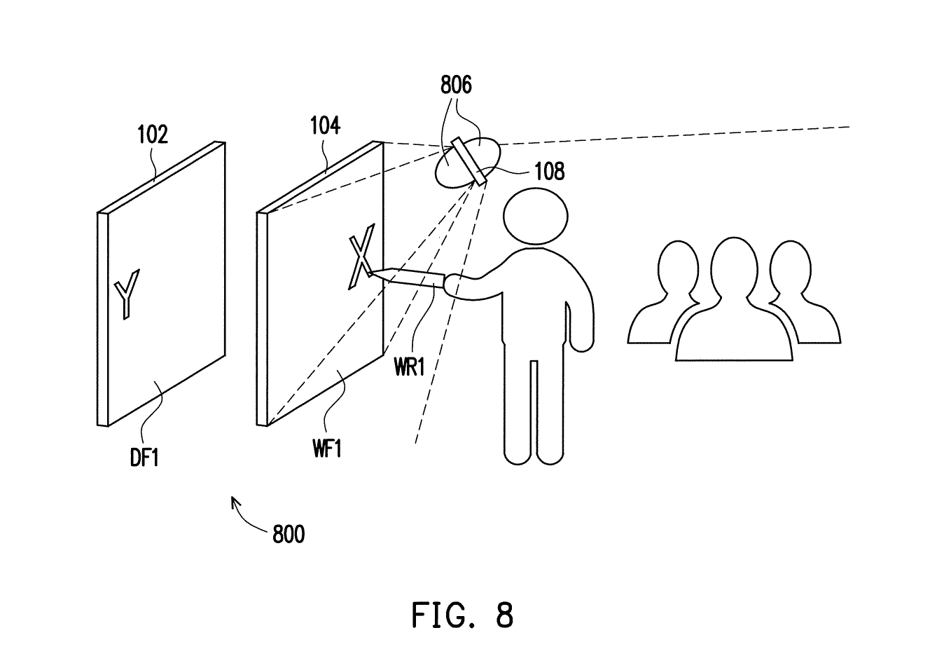

FIG. 8 is a schematic diagram of an electronic whiteboard according to the embodiments of the invention. Referring to FIG. 8, the embodiment of FIG. 8 differs from the embodiments of FIG. 1 in that an image capture device 806 of the embodiment may capture the display surface DF1 and the writing trajectory on the writing surface WF1, and may also capture an image of an environment in which an electronic whiteboard 800 is located. That is, a captured image may include a displayed image of the flat panel display 102, the writing trajectory of the writing instrument WR1, and an image of an environment in which the electronic whiteboard 800 is located, where an environment image includes, for example, a location of a course or a meeting and an image of a participant. The image capture device 806 may be, for example, a wide-angle camera, a fisheye camera, or a panoramic camera, but is not limited thereto. The network transmission module 108 may also transmits the captured image to the remote device, so that the user of the remote device may understand, according to the captured image, the displayed image of the flat panel display 102, the writing trajectory of the writing instrument WR1, and the location and participants of the course or the meeting.

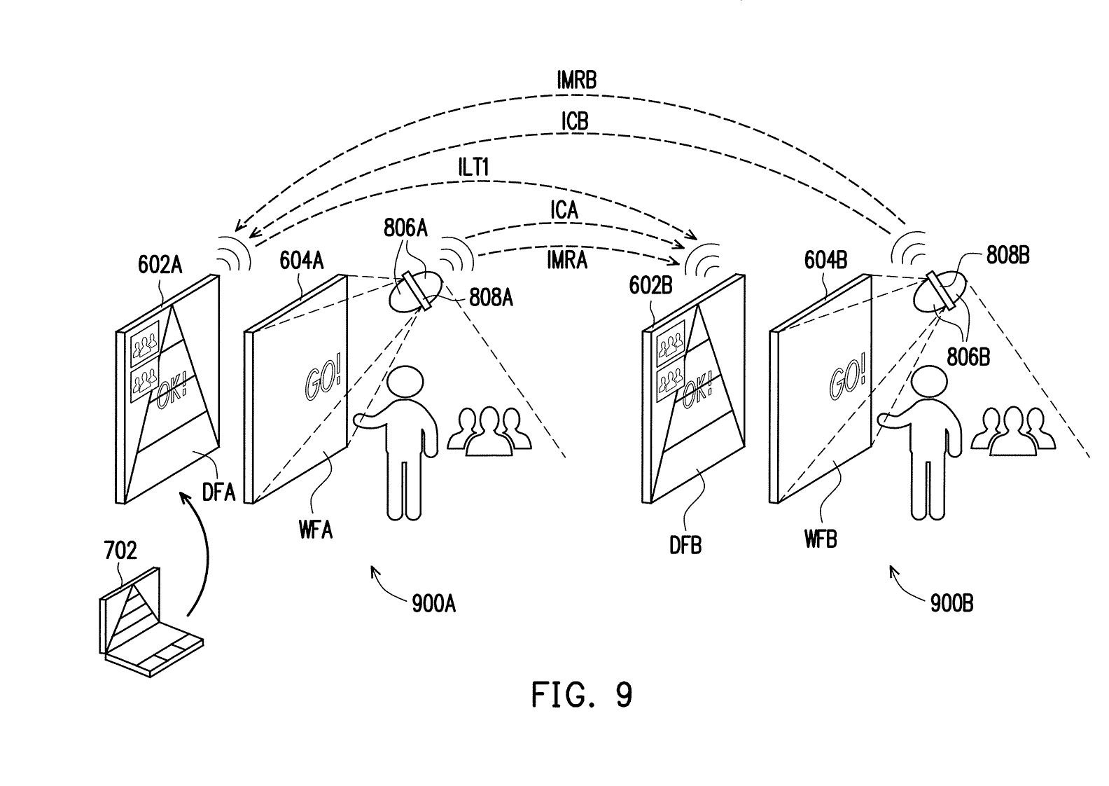

For example, FIG. 9 is a schematic diagram of an electronic whiteboard system according to the embodiments of the invention. Referring to FIG. 9, the embodiment of FIG. 9 differs from the embodiments of FIG. 7 in that a first image capture device 806A of a first electronic whiteboard 900A and a second image capture device 806B of a second electronic whiteboard 900B in the embodiment may respectively capture the first display surface DFA and the first writing trajectory on the first writing surface WFA, and the second display surface DFB and the second writing trajectory on the second writing surface WFB, and may also respectively capture images of environments in which the first electronic whiteboard 900A and the second electronic whiteboard 900B are located. In addition, a first captured image IMRA including the images of the location and the participants of the course or the meeting may further be transmitted to the second flat panel display 602B by a first network transmission module 808A to be displayed; and a second captured image IMRB including the images of the location and the participants of the course or the meeting may further be transmitted to the second flat panel display 602B by a second network transmission module 808B to be displayed. In this way, both users of the first electronic whiteboard 900A and the second electronic whiteboard 900B may further know about participants and locations of the course or the meeting of the other party, so as to better improve convenience of use of the electronic whiteboard system.

Based on the above, the electronic whiteboard, the electronic whiteboard system, and the operation method of the electronic whiteboard system according to the embodiments of the invention at least have one of the following advantages: a captured image including a display surface of a flat panel display and a writing trajectory may be transmitted to a remote device through network by using an electronic whiteboard, so that the electronic whiteboard may synchronously display or interact with the remote device, so as to greatly improve convenience of use of the electronic whiteboard system.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An electronic whiteboard, comprising:
a flat panel display, comprising a display surface;
a transparent plate, configured on the display surface and comprising a writing surface opposite to the display surface, wherein the writing surface is adapted to receive a writing operation of a writing instrument;
an image capture device, coupled to the flat panel display, and configured to capture an image of the transparent plate to generate a captured image, wherein the captured image comprises at least one of the display surface of the flat panel display and a writing trajectory of the writing instrument; and
a network transmission module, coupled to the image capture device, and configured to transmit the captured image to a remote device through network.

2. The electronic whiteboard according to claim 1, further comprising:
a controller, coupled to the flat panel display, the image capture device and the network transmission module, and configured to control the flat panel display to display an image, control the image capture device to perform image capturing, and control the network transmission module to transmit the captured image.

3. The electronic whiteboard according to claim 1, wherein the transparent plate comprises a light incident surface vertical to the writing surface, and the electronic whiteboard further comprises:
a light source, configured beside the light incident surface, and adapted to provide a light beam entering the transparent plate from the light incident surface, wherein the light beam is totally reflected in the transparent plate by the writing surface which does not comprise the writing trajectory, and leaves the transparent plate from the writing trajectory on the writing surface.

4. The electronic whiteboard according to claim 1, wherein the transparent plate comprises a light incident surface vertical to the writing surface and a patterned scattering structure, and the electronic whiteboard further comprises:
a light source, configured beside the light incident surface, and adapted to provide a light beam entering the transparent plate from the light incident surface, wherein the patterned scattering structure is adapted to guide the light beam to leave from the writing surface, and the writing trajectory shields a part of the light beam leaving from the writing surface.

5. The electronic whiteboard according to claim 4, wherein the transparent plate further comprises an upper plate and a lower plate, the lower plate is located between the flat panel display and the upper plate, the writing surface is located at the upper plate, and the light incident surface and the patterned scattering structure are located at the lower plate.

6. The electronic whiteboard according to claim 4, wherein the light source provides the light beam when the flat panel display is turned off.

7. The electronic whiteboard according to claim 3, wherein the light source provides the light beam when the flat panel display is turned off.

8. The electronic whiteboard according to claim 1, further comprising:
a polymer dispersed liquid crystal layer, configured between the flat panel display and the transparent plate, and adapted to be switched into a transparent state when the flat panel display displays an image and be switched into a non-transparent state when the flat panel display is turned off.

9. The electronic whiteboard according to claim 1, wherein the flat panel display displays a default image when the image capture device performs image capturing.

10. The electronic whiteboard according to claim 1, further comprising:
a transmission control button, wherein when the transmission control button receives a press operation, the image capture device captures the image of the transparent plate, and the network transmission module transmits the captured image to the remote device through network.

11. The electronic whiteboard according to claim 1, further comprising:
a storage device, coupled to the image capture device, adapted to store the captured image.

12. The electronic whiteboard according to claim 1, wherein the captured image further comprises an image of an environment in which the electronic whiteboard is located.

13. The electronic whiteboard according to claim 1, wherein the flat panel display further displays the image of the environment in which the electronic whiteboard is located.

14. An electronic whiteboard system, comprising:
a first electronic whiteboard, comprising:
a first flat panel display, comprising a first display surface;
a first transparent plate, configured on the first display surface and comprising a first writing surface opposite to the first display surface, wherein the first writing surface is adapted to receive a writing operation of a first writing instrument;
a first image capture device, coupled to the first flat panel display, and configured to capture an image of the first transparent plate to generate a first captured image, wherein the first captured image comprises at least one of the first display surface of the first flat panel display and a first writing trajectory of the first writing instrument; and
a first network transmission module, coupled to the first image capture device; and
a second electronic whiteboard, comprising:
a second flat panel display, comprising a second display surface;
a second transparent plate, configured on the second display surface and comprising a second writing surface opposite to the second display surface, wherein the second writing surface is adapted to receive a writing operation of a second writing instrument;
a second image capture device, coupled to the second flat panel display, and configured to capture an image of the second transparent plate to generate a second captured image, wherein the second captured image comprises at least one of the second display surface of the second flat panel display and a second writing trajectory of the second writing instrument; and
a second network transmission module, coupled to the second image capture device, and transmitting the first captured image and the second captured image through network with the first network transmission module, wherein the first flat panel display displays the second writing trajectory based on the second captured image, and the second flat panel display displays the first writing trajectory based on the first captured image, so as to synchronize images of the writing trajectories of the first captured image and the second captured image.

15. The electronic whiteboard system according to claim 14, wherein the first transparent plate comprises a first light incident surface vertical to the first writing surface, and the first electronic whiteboard further comprises:
a light source, configured beside the first light incident surface, and adapted to provide a light beam entering the first transparent plate from the first light incident surface, wherein the light beam is totally reflected in the first transparent plate by the first writing surface which does not comprise the first writing trajectory, and leaves the first transparent plate from the first writing trajectory on the first writing surface.

16. The electronic whiteboard system according to claim 14, wherein the first transparent plate comprises a first light incident surface vertical to the first writing surface and a first patterned scattering structure, and the first electronic whiteboard further comprises:
a light source, configured beside the first light incident surface, and adapted to provide a light beam entering the first transparent plate from the first light incident surface, wherein the first patterned scattering structure is adapted to guide the light beam to leave from the first writing surface, and the first writing trajectory shields a part of the light beam leaving from the first writing surface.

17. The electronic whiteboard system according to claim 14, wherein the first electronic whiteboard further comprises:
a polymer dispersed liquid crystal layer, configured between the first flat panel display and the first transparent plate, and adapted to be switched into a transparent state when the first flat panel display displays an image and be switched into a non-transparent state when the first flat panel display is turned off.

18. The electronic whiteboard system according to claim 14, wherein the first flat panel display and the second flat panel display respectively display a default image when the first image capture device and the second image capture device perform image capturing.

19. The electronic whiteboard system according to claim 14, wherein the first electronic whiteboard and the second electronic whiteboard respectively comprises:
a transmission control button, wherein when the transmission control button receives a press operation, the first image capture device captures the image of the first transparent plate, or the second image capture device captures the image of the second transparent plate, or the first image capture device captures the image of the first transparent plate and the second image capture device captures the image of second transparent plate, and the first network transmission module and the second network transmission module transmit the first captured image and the second captured image through the network with each other.

20. The electronic whiteboard system according to claim 14, wherein the first electronic whiteboard and the second electronic whiteboard respectively comprises:
a storage device, coupled to the first image capture device and the second image capture device, adapted to store the first captured image and the second captured image.

21. An operation method of an electronic whiteboard system, wherein the electronic whiteboard system comprises a first electronic whiteboard and a remote device, the first electronic whiteboard comprises a first flat panel display, a first transparent plate, a first image capture device, and a first network transmission module, the first flat panel display comprises a first display surface, the first transparent plate is configured on the first display surface and comprises a first writing surface opposite to the first display surface, and the operation method of the electronic whiteboard system comprises:
capturing an image of the first transparent plate to generate a first captured image, the first captured image comprising at least one of the first display surface of the first flat panel display and a first writing trajectory of the first writing instrument on the first writing surface; and
transmitting the first captured image to the remote device through network.

22. The operation method of the electronic whiteboard system according to claim 21, wherein the remote device comprises a second electronic whiteboard, the second electronic whiteboard comprises a second flat panel display, a second transparent plate, a second image capture device, and a second network transmission module, the second flat panel display comprises a second display surface, the second transparent plate is configured on the second display surface and comprises a second writing surface opposite to the second display surface, and the operation method of the electronic whiteboard system comprises:
capturing an image of the second transparent plate to generate a second captured image, the second captured image comprising at least one of the second display surface of the second flat panel display and a second writing trajectory of the second writing instrument on the second writing surface; and
receiving the first captured image by the second network transmission module and transmitting the second captured image to the first network transmission module through the network, the first flat panel display displays the second writing trajectory based on the second captured image, and the second flat panel display displays the first writing trajectory based on the first captured image, so as to synchronize images of the writing trajectories of the first captured image and the second captured image.

23. The operation method of the electronic whiteboard system according to claim 21, wherein the first transparent plate comprises a first light incident surface vertical to the first writing surface, and the operation method of the electronic whiteboard system further comprises:
providing a light beam entering the first transparent plate from the first light incident surface, wherein the light beam is totally reflected in the first transparent plate by the first writing surface which does not comprise the first writing trajectory, and leaves the first transparent plate from the first writing trajectory on the first writing surface.

24. The operation method of the electronic whiteboard system according to claim 21, wherein the first transparent plate comprises a first light incident surface vertical to the first writing surface and a first patterned scattering structure, and the operation method of the electronic whiteboard system further comprises:
providing a light beam entering the first transparent plate from the first light incident surface, wherein the first patterned scattering structure is adapted to guide the light beam to leave from the first writing surface, and the first writing trajectory shields a part of the light beam leaving from the first writing surface.

25. The operation method of the electronic whiteboard system according to claim 21, wherein the first electronic whiteboard further comprises a polymer dispersed liquid crystal layer configured between the first flat panel display and the first transparent plate, and the operation method of the electronic whiteboard system further comprises:
being switched into a transparent state when the first flat panel display displays an image and being switched into a non-transparent state when the first flat panel display is turned off.

26. The operation method of the electronic whiteboard system according to claim 21, further comprising:
enabling the first flat panel display to display a default image when the first image capture device performs image capturing.

27. The operation method of the electronic whiteboard system according to claim 21, wherein the first electronic whiteboard further comprises a transmission control button, and the operation method of the electronic whiteboard system further comprises:
when the transmission control button receives a press operation, capturing the image of the first transparent plate, and transmitting the first captured image to the remote device.

28. The operation method of the electronic whiteboard system according to claim 21, further comprising:
storing the first captured image.
